(19) United States
(12) Patent Application Publication
(10) Pub. No.: US 2017/0125773 A1
(43) Pub. Date: May 4, 2017

(54) Battery Interconnect System

(71) Applicant: Atieva, Inc., Menlo Park, CA (US)

(72) Inventor: Albert Liu, Palo Alto, CA (US)

(73) Assignee: ATIEVA, INC., Menlo Park, CA (US)

(21) Appl. No.: 14/927,826

(22) Filed: Oct. 30, 2015

(51) Int. Cl. H01M 2/20; H01M 10/0525; B23K 26/22; B23K 11/11; B23K 20/02; B23K 20/10; B23K 11/00; H01M 2/30; B23K 15/00

(52) U.S. Cl. CPC H01M 2/206; H01M 2/30; H01M 10/0525; B23K 26/22; B23K 15/008; B23K 15/0006; B23K 20/023; B23K 20/10; B23K 11/0046; B23K 11/11; H01M 2220/20

(57) ABSTRACT

A system and a corresponding method are provided for interconnecting the batteries in a battery pack in a manner that is designed to simplify the connection process, thereby improving throughput. The system uses two different types of interconnects; wire and ribbon interconnects. The wire interconnects are attached to each battery's large contact area terminal nub while the ribbon interconnects are attached to the crimped edge region of each battery's case.

### FIELD OF THE INVENTION

The present invention relates generally to battery packs and, more particularly, to a battery pack bus bar interconnect system.

### BACKGROUND OF THE INVENTION

In response to the demands of consumers who are driven both by ever-escalating fuel prices and the dire consequences of global warming, the automobile industry is slowly starting to embrace the need for ultra-low emission, high efficiency cars. One of the most common approaches to achieving a low emission, high efficiency car is through the use of a hybrid drive train in which an internal combustion engine is combined with one or more electric motors. An alternate approach that is intended to reduce emissions even further while simultaneously decreasing drive train complexity is one in which the internal combustion engine is completely eliminated from the drive train, thus requiring that all propulsive power be provided by one or more electric motors. Regardless of the approach used to achieve lower emissions, in order to meet overall consumer expectations it is critical that the drive train maintains reasonable levels of performance, range, reliability, and cost.

Irrespective of whether an electric vehicle (EV) uses a hybrid or an all-electric drive train, the battery pack employed in such a car presents the vehicle's design team and manufacturer with various trade-offs from which to select. For example, the size of the battery pack affects the vehicle's weight, performance, driving range, available passenger cabin space and cost. Battery performance is another characteristic in which there are numerous trade-offs, such as those between power density, charge rate, life time, degradation rate, battery stability and inherent battery safety. Other battery pack design factors include cost, both per battery and per battery pack, material recyclability, and battery pack thermal management requirements.

In order to lower battery pack cost and thus the cost of an EV, it is critical to reduce both component cost and assembly time. An area of pack fabrication that has a large impact on assembly time, especially for large packs utilizing small form factor batteries, is the procedure used to connect the batteries together, where the batteries are typically grouped together into modules which are then interconnected within the pack to achieve the desired output power. In a conventional pack, the high current interconnects that electrically connect each terminal of each battery to the corresponding bus bar are typically comprised of wire, i.e., wire bonds. Unfortunately wire bonding is a very time consuming, and thus costly, process and one which may introduce reliability issues under certain manufacturing conditions.

Accordingly, what is needed is a robust interconnect system that allows the battery pack to be quickly and efficiently assembled, thus lowering manufacturing time and cost. The present invention provides such an interconnect design and manufacturing process.

### SUMMARY OF THE INVENTION

The present invention provides a method of electrically interconnecting a plurality of batteries contained within a battery pack, the method including the steps of (i) coupling a first terminal of each battery of the plurality of batteries to a first bus bar using a plurality of wire interconnects, where each wire interconnect of the plurality of wire interconnects has a substantially circular cross-section; and (ii) coupling a second terminal of each battery of the plurality of batteries to a second bus bar using a plurality of ribbon interconnects, where each ribbon interconnect of the plurality of ribbon interconnects has a substantially rectangular cross-section. The step of coupling the first terminal of each battery to the first bus bar may further comprise coupling a large contact area terminal nub corresponding to the first terminal of each battery to the first bus bar using the plurality of wire interconnects, where the large contact area terminal nub is integrated into a central region of each battery's cap assembly. The method may further comprise the step of attaching each wire interconnect to the large contact area terminal nub and to the first bus bar using a technique selected from the group consisting of laser welding, e-beam welding, resistance welding, ultrasonic bonding, thermocompression bonding and thermosonic bonding. The step of coupling the second terminal of each battery to the second bus bar may further comprise coupling a crimped edge region corresponding to the second terminal of each battery to the second bus bar using the plurality of ribbon interconnects, where the crimped edge region of each battery is integral to each battery's case. The method may further comprise the step of attaching each ribbon interconnect to the crimped edge region and to the second bus bar using a technique selected from the group consisting of laser welding, e-beam welding, resistance welding, ultrasonic bonding, thermocompression bonding and thermosonic bonding.

The present invention also provides a battery pack that is comprised of (i) a plurality of batteries, where each battery of the plurality of batteries is comprised of a first battery terminal and a second battery terminal, where the first battery terminal of each battery is comprised of a large contact area terminal nub integrated into a central region of each battery's cap assembly, and where the second battery terminal of each battery is comprised of a crimped edge region integral to each battery's casing; (ii) a first bus bar; (iii) a second bus bar; (iv) a first plurality of interconnects comprising a plurality of wire interconnects, where each wire interconnect of the plurality of wire interconnects has a substantially circular cross-section, where a first end portion of each wire interconnect is attached to the first bus bar, and where a second end portion of each wire interconnect distal from the first end portion is attached to the large contact area terminal nub of one of the plurality of batteries; and (v) a second plurality of interconnects comprising a plurality of ribbon interconnects, where each ribbon interconnect of the plurality of ribbon interconnects has a substantially rectangular cross-section, where a first end portion of each ribbon interconnect is attached to the second bus bar, and where a second end portion of each ribbon interconnect distal from the first end portion is attached to the crimped edge region of one of the plurality of batteries. Each wire interconnect of the plurality of wire interconnects may be comprised of a fusible interconnect. The first end portion of each wire interconnect is attached to the first bus bar via a first bond and the second end portion of each wire interconnect is attached to the large contact area terminal nub via a second bond, where the first and second bonds may be formed via a technique selected from laser welding, e-beam welding, resistance welding, ultrasonic bonding, thermocompression bonding and thermosonic bonding. The first end portion of each ribbon interconnect is attached to the second bus bar via a third bond and the second end portion of each ribbon interconnect is attached to the crimped edge region via a fourth bond, where the third and fourth bonds may be formed via a technique selected from the group consisting of laser welding, e-beam welding, resistance welding, ultrasonic bonding, thermocompression bonding and thermosonic bonding.

A further understanding of the nature and advantages of the present invention may be realized by reference to the remaining portions of the specification and the drawings.

### BRIEF DESCRIPTION OF THE DRAWINGS

It should be understood that the accompanying figures are only meant to illustrate, not limit, the scope of the invention and should not be considered to be to scale. Additionally, the same reference label on different figures should be understood to refer to the same component or a component of similar functionality.

FIG. 1 is a schematic diagram of a battery pack with bus bars above and below the battery cells in accordance with the prior art;

FIG. 2 is a schematic diagram of a battery pack with bus bars adjacent to the positive terminals of the battery cells in accordance with the prior art; and

FIG. 3 provides a top view of a portion of a battery assembly, and in particular the battery to bus bar interconnects of the invention.

### DESCRIPTION OF THE SPECIFIC EMBODIMENTS

As used herein, the singular forms “a”, “an” and “the” are intended to include the plural forms as well, unless the context clearly indicates otherwise. The terms “comprises”, “comprising”, “includes”, and/or “including”, as used herein, specify the presence of stated features, integers, steps, operations, elements, and/or components, but do not preclude the presence or addition of one or more other features, integers, steps, operations, elements, components, and/or groups thereof. As used herein, the term “and/or” and the symbol “/” are meant to include any and all combinations of one or more of the associated listed items. Additionally, while the terms first, second, etc. may be used herein to describe various steps or calculations, these steps or calculations should not be limited by these terms, rather these terms are only used to distinguish one step or calculation from another. For example, a first calculation could be termed a second calculation, and, similarly, a first step could be termed a second step, without departing from the scope of this disclosure.

In the following text, the terms “battery”, “cell”, and “battery cell” may be used interchangeably and may refer to any of a variety of different battery configurations and chemistries. Typical battery chemistries include, but are not limited to, lithium ion, lithium ion polymer, nickel metal hydride, nickel cadmium, nickel hydrogen, nickel zinc, and silver zinc. The terms “electric vehicle” and “EV” may be used interchangeably and may refer to an all-electric vehicle, a plug-in hybrid vehicle, also referred to as a PHEV, or a hybrid vehicle, also referred to as a HEV, where a hybrid vehicle utilizes multiple sources of propulsion including an electric drive system.

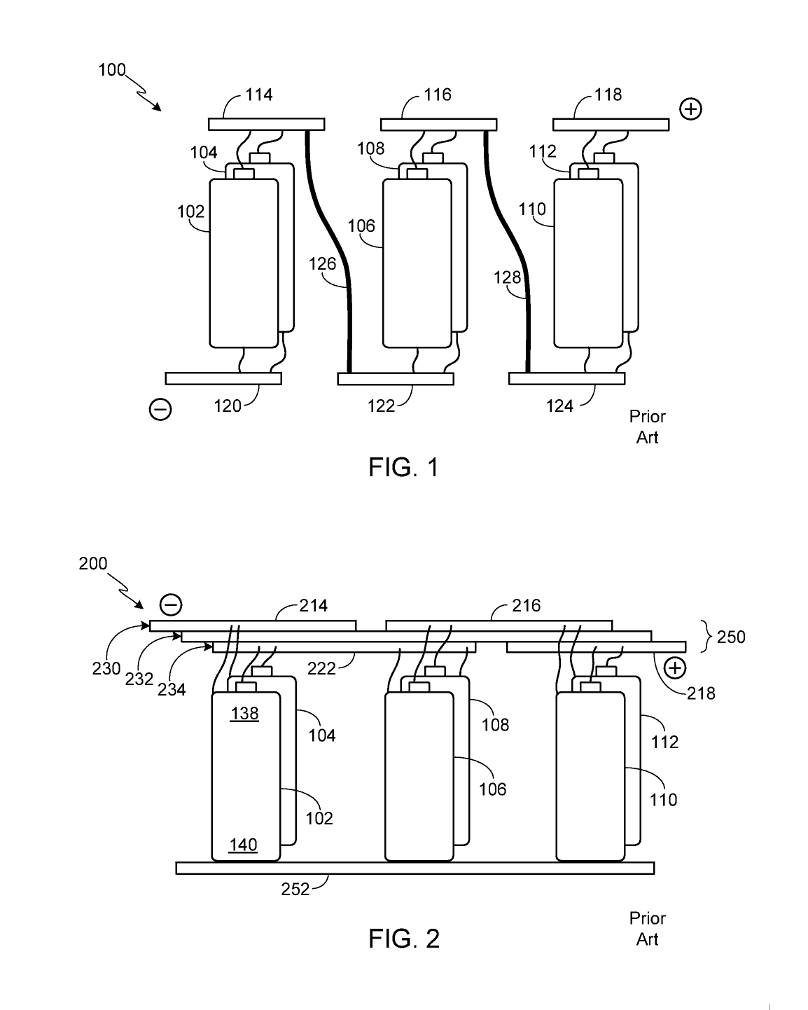

FIG. 1 illustrates an exemplary battery pack 100 illustrating a common battery pack configuration in accordance with the prior art. As shown, battery pack 100 includes a first group of batteries 102 and 104 connected in parallel, a second group of batteries 106 and 108 connected in parallel, and a third group of batteries 110 and 112 connected in parallel. The first, second and third groups of batteries are connected in series. Bus bars 114, 116, 118, 120, 122, 124 are used to connect the batteries in this parallel and series arrangement. Each of the bus bars is coupled to the respective batteries with one or more interconnects. A relatively thick wire 126 couples the second bus bar 114 to the third bus bar 122, making a series connection between the first and second battery groups, while a second relatively thick wire 128 couples the fourth bus bar 116 to the fifth bus bar 124, making a series connection between the second and third battery groups. As a result, the first bus bar 120 is the negative terminal while the sixth bus bar 118 is the positive terminal for battery pack 100.

The use of bus bars at both ends of the batteries as illustrated in FIG. 1 requires a relatively complex manufacturing process in order to (i) attach the battery interconnects between the battery end surfaces and the bus bars, and (ii) attach the wires (e.g., wires 126 and 128) that couple the upper bus bars to the lower bus bars. Wires 126 and 128 are also problematic in the sense that they can introduce parasitic resistance into the current path, which in turn can introduce a voltage drop under high current drain conditions. Additionally this configuration prevents, or at least limits, the ability to efficiently remove battery pack heat by affixing a heat sink to a battery end surface.

FIG. 2 illustrates a battery pack 200 utilizing an alternate conventional battery pack configuration in which all the bus bars are proximate to one end of the battery pack, thereby enabling efficient heat removal from the other end of the battery pack. Furthermore, by locating bus bars 214, 216, 218 and 222 proximate to one end of the batteries, fewer bus bars are required than in battery pack 100. The relatively thick wires 126 and 128 from the upper bus bars to the lower bus bars are also eliminated in the embodiment shown in FIG. 2.

Access to both the positive and negative terminals in battery pack 200 is at one end of the cells, i.e., at the top end of the cells, where the bus bars are coupled to the positive and negative terminals using battery interconnects. As in the prior arrangement, the first group of batteries 102 and 104 are connected in parallel, the second group of batteries 106 and 108 are connected in parallel, and the third group of batteries 110 and 112 are connected in parallel. The first, second and third groups of batteries are connected in series. Bus bars 214, 216, 218, 222 are used to couple the batteries in this parallel and series arrangement. Specifically, starting with the negative terminal of battery pack 200, a first bus bar 214 is connected to the negative terminals of the first group of batteries 102 and 104 while a second bus bar 222 is connected to the positive terminals of the same group of batteries 102 and 104, both at the top end portion 138 of each of the batteries. The first and second bus bars 214 and 222 couple the first group of batteries 102 and 104 in parallel. Similarly, the second bus bar 222 and the third bus bar 216 couple the second group of batteries 106 and 108 in parallel, while the third bus bar 216 and the fourth bus bar 218 couple the third group of batteries 110 and 112 in parallel. Series connections between battery groups are formed by the bus bars, specifically the second bus bar 222 connects the positive terminals of the first group of batteries 102 and 104 to the negative terminals of the second group of batteries 106 and 108; and the third bus bar 216 connects the positive terminals of the second group of batteries 106 and 108 to the negative terminals of the third group of batteries 110 and 112. The fourth bus bar 218 is the positive terminal of the battery pack 200.

In battery pack 200 the bus bars are arranged in a layer stack 250. In this stacking arrangement first bus bar 214 and third bus bar 216, which are separated by an air gap or other electrical insulator to prevent short circuiting, are placed in a first layer 230. Similarly, second bus bar 222 and fourth bus bar 218, which are also separated by a gap or insulator, are placed in a third layer 234. Disposed between layers 230 and 234 is an electrically insulating layer 232. To simplify fabrication, the layer stack may be formed using layers of a circuit board, e.g., with the bus bars made of (or on) copper layers or other suitable conductive metal (such as aluminum) and the insulating layer made of resin impregnated fiberglass or other suitable electrically insulating material. It should be understood that layer stack 250 is simply an exemplary stack and that alternate bus bar arrangements may be used.

In many conventional battery packs, and as shown in the figures, the batteries have a projecting nub as a positive terminal at the top end of the battery and a can (i.e., case or casing) that serves as the negative battery terminal. The batteries are preferably cylindrically shaped with a flat bottom surface. Typically a portion of the negative terminal is located at the top end of the cell, for example due to a casing crimp which is formed when the casing is sealed around the contents of the battery. This crimp or other portion of the negative terminal at the top end of the battery provides physical and electrical access to the battery's negative terminal. The crimp is spaced apart from the peripheral sides of the projecting nub through a gap that may or may not be filled with an insulator.

Preferably in a battery pack such as battery pack 200 in which the battery connections are made at one end of the cells (e.g., end portions 138), a heat sink 252 is thermally coupled to the opposite end portions 140 of each of the batteries. The heat sink may be finned or utilize air or liquid coolant passages. In some embodiments, a fan provides air flow across a surface of heat sink 252. In at least one embodiment, the heat sink is attached or affixed to the bottom of a battery holder. The co-planar arrangement of the batteries provides a relatively flat surface to attach a heat sink and in some embodiments the battery cells are designed to cool efficiently through the bottom of the cells, e.g., 18650 lithium ion batteries.

While wire bond interconnects offer a number of benefits, for example the ability to use the wire bond as a fusible link, this type of interconnect suffers from several significant drawbacks, the primary drawback being the time, and thus cost, required to couple the wire to the crimped region of the battery. This problem, which is common when the battery pack design requires that both interconnects be coupled to the top portion of the batteries, is due to the limited diameter of the wire and the limited area offered by the crimped battery case. When coupling the wire to the crimped region of a battery, i.e., the edge of the battery case, the pattern recognition system used in a conventional wire bonding machine takes a long time to align the wire with the crimped region due to the small feature sizes. Additionally, due to the limited bonding area, this bond is prone to failure, thus often requiring re-bonding to correct the failed bond.

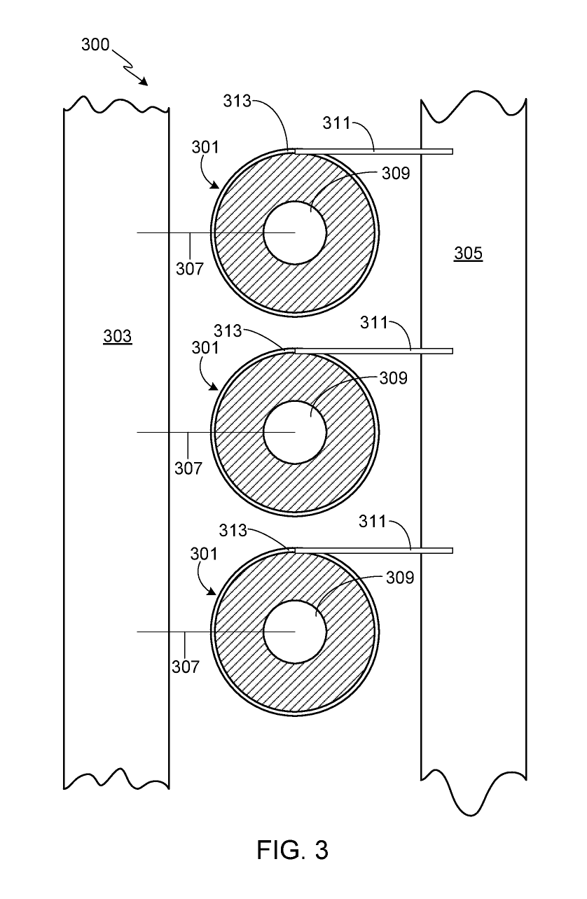

FIG. 3 illustrates the interconnects used in accordance with the present invention when both battery interconnects are coupled to the top region of the battery. In this figure a portion 300 of a battery pack is shown that includes three batteries 301 coupled to a pair of bus bars 303 and 305. It should be understood, however, that the present invention is not limited to either a minimum or maximum number of batteries, nor is the present invention limited to a specific bus bar configuration.

Per the invention, each of the battery interconnects corresponding to one set of battery interconnects is comprised of a wire interconnect 307 (e.g., an interconnect with a substantially circular cross-section), these interconnects coupling bus bar 303 to terminal nub 309. Preferably each wire interconnect 307 is comprised of a fusible interconnect, i.e., an interconnect with a large enough diameter to allow it to carry the desired current while having a small enough diameter to insure that it will break when the desired current is exceeded by a preset amount. As shown, terminal nub 309, which is preferably centered in the battery cap assembly, provides a large contact area. Due to the large contact area associated with terminal nubs 309, even though interconnects 307 are wire interconnects and preferably applied using a conventional wire-bonding technique, these interconnects can be rapidly and efficiently bonded to the terminal nubs. The second set of interconnects are comprised of ribbon interconnects 311 (e.g., an interconnect with a substantially rectangular cross-section) and are used to couple the relatively small crimped edge region 313 of each battery 301 with second bus bar 305. Even though the crimped edge region 313 of each battery 301 is relatively small and often includes size variations that result from the standard manufacturing tolerances used by battery manufacturers, the large surface area offered by the ribbon interconnects 311 allow these interconnects to be rapidly and efficiently bonded to the crimped edge of the corresponding battery casings. Typically this combination of interconnect types allows both sets of interconnects to be bonded to the batteries and bus bars at the same, or similar, fabrication speed. Additionally, due to the large surface area corresponding to terminals 309 for the first set of interconnects, and the large surface area corresponding to ribbon interconnects 311 for the second set of interconnects, typically both sets of interconnects have a relatively low failure rate.

Preferably both types of interconnects are applied using a conventional processing system, for example a wire-bonding system for use with interconnects 307 and a fiber-bonding system for use with interconnects 311. Both types of interconnects may be coupled to the underlying surfaces, i.e., the battery terminals and the bus bars, using any conventional coupling technique. Exemplary coupling techniques include laser welding (e.g., laser oscillation welding, laser micro welding), e-beam welding, resistance welding, ultrasonic bonding, thermosonic bonding, and thermocompression bonding.

Systems and methods have been described in general terms as an aid to understanding details of the invention. In some instances, well-known structures, materials, and/or operations have not been specifically shown or described in detail to avoid obscuring aspects of the invention. In other instances, specific details have been given in order to provide a thorough understanding of the invention. One skilled in the relevant art will recognize that the invention may be embodied in other specific forms, for example to adapt to a particular system or apparatus or situation or material or component, without departing from the spirit or essential characteristics thereof. Therefore the disclosures and descriptions herein are intended to be illustrative, but not limiting, of the scope of the invention.

What is claimed is:

1. A method of electrically interconnecting a plurality of batteries contained within a battery pack, said method comprising:
coupling a first terminal of each battery of said plurality of batteries to a first bus bar using a plurality of wire interconnects, wherein each wire interconnect of said plurality of wire interconnects has a substantially circular cross-section; and
coupling a second terminal of each battery of said plurality of batteries to a second bus bar using a plurality of ribbon interconnects, wherein each ribbon interconnect of said plurality of ribbon interconnects has a substantially rectangular cross-section.

2. The method of claim 1, said step of coupling said first terminal of each battery of said plurality of batteries to said first bus bar further comprises coupling a large contact area terminal nub corresponding to said first terminal of each battery of said plurality of batteries to said first bus bar using said plurality of wire interconnects, wherein said large contact area terminal nub is integrated into a central region of a battery cap assembly.

3. The method of claim 2, further comprising the step of attaching each wire interconnect of said plurality of wire interconnects to said large contact area terminal nub and to said first bus bar using a technique selected from the group consisting of laser welding, e-beam welding, resistance welding, ultrasonic bonding, thermocompression bonding and thermosonic bonding.

4. The method of claim 1, said step of coupling said second terminal of each battery of said plurality of batteries to said second bus bar further comprises coupling a crimped edge region corresponding to said second terminal of each battery of said plurality of batteries to said second bus bar using said plurality of ribbon interconnects, wherein said crimped edge region of each battery is integral to a battery casing corresponding to each battery.

5. The method of claim 4, further comprising the step of attaching each ribbon interconnect of said plurality of ribbon interconnects to said crimped edge region and to said second bus bar using a technique selected from the group consisting of laser welding, e-beam welding, resistance welding, ultrasonic bonding, thermocompression bonding and thermosonic bonding.

6. The method of claim 1, wherein:
said step of coupling said first terminal of each battery of said plurality of batteries to said first bus bar further comprises coupling a large contact area terminal nub corresponding to said first terminal of each battery of said plurality of batteries to said first bus bar using said plurality of wire interconnects, wherein said large contact area terminal nub is integrated into a central region of a battery cap assembly; and
said step of coupling said second terminal of each battery of said plurality of batteries to said second bus bar further comprises coupling a crimped edge region corresponding to said second terminal of each battery of said plurality of batteries to said second bus bar using said plurality of ribbon interconnects, wherein said crimped edge region of each battery is integral to a battery casing corresponding to each battery.

7. The method of claim 6, further comprising:
attaching each wire interconnect of said plurality of wire interconnects to said large contact area terminal nub and to said first bus bar using a technique selected from the group consisting of laser welding, e-beam welding, resistance welding, ultrasonic bonding, thermocompression bonding and thermosonic bonding; and
attaching each ribbon interconnect of said plurality of ribbon interconnects to said crimped edge region and to said second bus bar using a technique selected from the group consisting of laser welding, e-beam welding, resistance welding, ultrasonic bonding, thermocompression bonding and thermosonic bonding.

8. A battery pack, comprising:
a plurality of batteries, each battery of said plurality of batteries comprising a first battery terminal and a second battery terminal, said first battery terminal of each battery of said plurality of batteries comprising a large contact area terminal nub integrated into a central region of a battery cap assembly, and said second battery terminal of each battery of said plurality of batteries comprising a crimped edge region integral to a battery casing corresponding to each battery of said plurality of batteries;
a first bus bar;
a second bus bar;
a first plurality of interconnects comprising a plurality of wire interconnects, wherein each wire interconnect of said plurality of wire interconnects has a substantially circular cross-section, wherein a first end portion of each wire interconnect is attached to said first bus bar, and wherein a second end portion of each wire interconnect distal from said first end portion is attached to said large contact area terminal nub of one of said plurality of batteries; and
a second plurality of interconnects comprising a plurality of ribbon interconnects, wherein each ribbon interconnect of said plurality of ribbon interconnects has a substantially rectangular cross-section, wherein a first end portion of each ribbon interconnect is attached to said second bus bar, and wherein a second end portion of each ribbon interconnect distal from said first end portion is attached to said crimped edge region of one of said plurality of batteries.

9. The battery pack of claim 8, wherein each wire interconnect of said plurality of wire interconnects is comprised of a fusible interconnect.

10. The battery pack of claim 8, wherein said first end portion of each wire interconnect is attached to said first bus bar via a first bond, wherein said second end portion of each wire interconnect is attached to said large contact area terminal nub via a second bond, and wherein said first and second bonds are formed via a technique selected from laser welding, e-beam welding, resistance welding, ultrasonic bonding, thermocompression bonding and thermosonic bonding.

11. The battery pack of claim 8, wherein said first end portion of each ribbon interconnect is attached to said second bus bar via a third bond, wherein said second end portion of each ribbon interconnect is attached to said crimped edge region via a fourth bond, and wherein said third and fourth bonds are formed via a technique selected from the group consisting of laser welding, e-beam welding, resistance welding, ultrasonic bonding, thermocompression bonding and thermosonic bonding.
